(19) United States
(12) Patent Application Publication
(10) Pub. No.: US 2025/0030087 A1
(43) Pub. Date: Jan. 23, 2025

(54) BATTERY PACK AND MANUFACTURING METHOD THEREOF

(71) Applicant: Honda Motor Co., Ltd., Tokyo (JP)

(72) Inventors: Fumio SATO, Tokyo (JP); Hiroki MAEMOTO, Tokyo (JP); Masashi MACHIDA, Tokyo (JP); Koichiro KINUGAWA, Tokyo (JP)

(73) Assignee: Honda Motor Co., Ltd., Tokyo (JP)

(21) Appl. No.: 18/757,527

(22) Filed: Jun. 28, 2024

(30) Foreign Application Priority Data
Jul. 19, 2023 (JP) 2023-117907

(51) Int. Cl. H01M 10/6557; H01M 10/613; H01M 10/6568; H01M 50/209

(52) U.S. Cl. CPC H01M 10/6557; H01M 10/613; H01M 10/6568; H01M 50/209

(57) ABSTRACT

A battery pack includes a battery case, battery cells, and coolant jackets. A cell joined body formed of the battery cells joined in a row and the coolant jacket are alternately arranged in surface contact with each other in a first direction. Each coolant jacket is connected to coolant circulation pipes provided on both sides in a second direction. At least apart of the coolant jackets is a reinforcing plate-type coolant jacket configured such that upper parts of both end parts in the second direction of the reinforcing plate-type coolant jacket are extended and are joined to upper parts of end plates of the battery case while avoiding the coolant circulation pipes to enhance a rigidity of the battery case.

### CROSS-REFERENCE TO RELATED APPLICATION

This application claims the priority benefit of Japan application serial no. 2023-117907, filed on Jul. 19, 2023. The entirety of the above-mentioned patent application is hereby incorporated by reference herein and made a part of this specification.

### BACKGROUND

### Technical Field

The disclosure relates to a battery pack for a battery electric vehicle (BEV) and a manufacturing method thereof.

### Related Art

Battery packs for battery electric vehicles (BEVs) are currently provided in a module-to-pack (MTP) form in which a plurality of cells are bundled tightly together to form a battery module, and a plurality of such modules are mounted into a battery case. Frames are installed at the battery case in a width direction and a front-rear direction of the vehicle to fix the modules and contribute to securing a rigidity of the battery case itself (e.g., Patent Document 1 (Japanese Patent Application Laid-Open No. 2013-16467)). Further, to deal with heat generation and the like during charging and discharging, battery cells are often provided with water jackets for cooling (and heating depending on the requirement) laid out under a module mounting part, and temperature management is performed from bottom surfaces of the battery cells.

While there is a demand for increasing a quantity of mounted batteries due to a battery capacity expansion and a voltage increase, the area available for mounting batteries in a vehicle body is limited. In the MTP form, the quantity of mounted batteries is limited by the space used by the structure body of each module. Thus, a cell-to-pack (CTP) form, which directly mounts cells into a battery case, is being considered (e.g., Patent Document 2 (Japanese Patent Application Laid-Open No. 2023-502274) and Patent Document 3 (Japanese Patent Application Laid-Open No. 2023-509695)). One CTP form is a method in which battery cells alone are densely mounted into a battery case without frames. In that case, although the mounting quantity can be increased, the rigidity of the battery case cannot be secured, and a deflection in the vicinity of a center of a bottom surface of the case becomes large. Thus, it is conceivable to install partition frames or bottom surface ribs. However, if frames are added, the quantity of mounted batteries decreases, so a method to secure the rigidity with as thin and as few frames as possible is sought. Nevertheless, it is conceivable that cooling components are likely to be installed on an inner bottom surface of the battery case, or a bus bar electrically connecting cells to each other is likely to be present when terminals are installed to face downward. Therefore, it is likely that lower surfaces of frames cannot be fully joined to the bottom surface, and furthermore, it is likely that end surfaces of frames cannot be fully joined to wall surfaces between the frames and sidewalls of the battery case because this space is used as routes of wiring and piping. On the other hand, another CTP form is a method in which battery cells and cooling components in contact with side surfaces of the battery cells are densely arranged alternately with each other. In that case, it is conceivable to cause the cooling components to function as frames. However, similarly due to the presence of a bus bar or securing of routes of wiring and piping, it is assumed that full surface joining with both the bottom surface and the side surfaces is not possible. For this reason, there is a demand for optimization of a frame structure capable of achieving a maximum rigidity improvement with minimal connection with the battery case.

### SUMMARY

A battery pack (1) of an embodiment of the disclosure includes: a battery case (10) in a substantially box shape extending in a first direction (A-A) and a second direction (B-B) that are orthogonal to each other and form a horizontal plane; a plurality of battery cells (20) arranged in the battery case (10); and a plurality of coolant jackets (30) including coolant passages (34) therein and cooling the plurality of battery cells (20). The plurality of battery cells (20) constitute cell joined bodies (20A) each with multiple battery cells arranged and joined in a row in the second direction (B-B). The cell joined body (20A) and the coolant jacket (30) are alternately arranged in surface contact with each other in the first direction (A-A). Each of the coolant jackets (30) is connected to coolant circulation pipes (40) provided on both sides in the second direction (B-B). At least a part of the coolant jackets (30) is a reinforcing plate-type coolant jacket (30R) configured such that upper parts of both ends in the second direction (B-B) of the reinforcing plate-type coolant jacket are extended in the second direction (B-B) and are joined to upper parts of end plates (13 and 14) constituting both end parts of the battery case (10) in the second direction (B-B) while avoiding the coolant circulation pipes (40) to enhance a rigidity of the battery case (10).

A manufacturing method of a battery pack according to another embodiment of the disclosure is a method of manufacturing a battery pack (1) including: a battery case (10) in a substantially box shape extending in a first direction (A-A) and a second direction (B-B) that form a horizontal plane and are orthogonal to each other; a plurality of battery cells (20) arranged in the battery case (10); and a plurality of coolant jackets (30) including coolant passages (34) therein and cooling the plurality of battery cells (20). The manufacturing method includes steps below. The plurality of battery cells (20) are arranged and joined, with multiple battery cells in each row in the second direction (B-B), to form a plurality of cell joined bodies (20A). The cell joined body (20A) and the coolant jacket (30) are arranged alternately in surface contact with each other in the first direction (A-A) in the battery case (10). Upper parts of both end parts in the second direction (B-B) of at least a part of the coolant jackets (30) are joined to upper part of end plates (13 and 14) constituting both end parts of the battery case (10) in the second direction (B-B) to enhance a rigidity of the battery case (10).

The reference signs in brackets above indicate reference signs of components corresponding to embodiments to be described later as examples of the disclosure.

### BRIEF DESCRIPTION OF DRAWINGS

FIG. 1 is a perspective view schematically showing a battery pack according to a first embodiment of the disclosure.

FIG. 2 is an enlarged perspective view of a part C of the battery pack in FIG. 1.

FIG. 3 is a perspective view of a part in FIG. 2 viewed from an arrow B direction, with a battery case removed and a part of sockets removed.

FIG. 4 is a perspective view schematically showing a cell joined body.

FIG. 5A and FIG. 5B are perspective views schematically showing a coolant jacket. FIG. 5A shows a normal coolant jacket, and FIG. 5B shows a reinforcing plate-type coolant jacket.

FIG. 6A and FIG. 6B are schematic cross-sectional views showing a relationship between a deflection of the battery pack and a torsion of left and right end plates. FIG. 6A shows a case with normal coolant jackets only, and FIG. 6B shows a case with reinforcing plate-type coolant jackets provided.

FIG. 7A, FIG. 7B, and FIG. 7C are views showing side frames approximating reinforcing plate-type coolant jackets and a relationship between a quantity of the side frames and a deflection amount of the battery pack.

FIG. 8 is a perspective view schematically showing the coolant jackets and the cell joined bodies.

FIG. 9 is a perspective view showing a manufacturing method of the battery pack in FIG. 1, showing a state in which a cell stack formed by arranging adhered bodies of the cell joined parts and the coolant jackets is inserted into the battery case, and a bus bar module is welded to the cell stack to form a cell body.

FIG. 10 is a perspective view showing the manufacturing method of the battery pack in FIG. 1, showing a formed cell body with the battery case provided.

FIG. 11 is a partially enlarged perspective view of a battery case of a battery pack according to a second embodiment of the disclosure.

FIG. 12 is a partially enlarged perspective view of the battery pack with battery cells and coolant jackets mounted in the battery case in FIG. 11.

### DESCRIPTION OF EMBODIMENTS

Embodiments of the disclosure improve a rigidity of a battery case while maintaining a battery capacity and a cooling function for battery cells.

Based on a trade-off relationship between a rigidity increase effect of frames (thin plates) installed in a battery case and a space loss, a necessary quantity has been calculated.

As reference conditions for calculating an optimal quantity, the frame has a thickness set to 8 mm and is installed as a rib that is not joined to a side frame (outer frame) of the battery case and is fully joined to a bottom plate. With a state without frames taken as a reference, a displacement amount in the case where a distributed load of the weight of the mounted batteries is applied to the case bottom surface has been calculated by simulation, and it has been determined at what point a decrease in the displacement amount of the bottom surface saturates as the quantity of frames increases. As a result, it can be said that it is possible to significantly reduce the displacement amount by causing nine frames to function.

This tendency is the same in simulations for more realistic cases in which only a part of the bottom surface is joined. However, in that case, the displacement amount increases, so in the disclosure, a frame shape with protrusions at upper parts of both ends is adopted, and the frames are brought into contact with upper parts of side frames (outer frames) of the battery case and adhered thereto to make it possible to significantly suppress the displacement amount.

A battery pack (1) of an embodiment of the disclosure includes: a battery case (10) in a substantially box shape extending in a first direction (A-A) and a second direction (B-B) that are orthogonal to each other and form a horizontal plane; a plurality of battery cells (20) arranged in the battery case (10); and a plurality of coolant jackets (30) including coolant passages (34) therein and cooling the plurality of battery cells (20). The plurality of battery cells (20) constitute cell joined bodies (20A) each with multiple battery cells arranged and joined in a row in the second direction (B-B). The cell joined body (20A) and the coolant jacket (30) are alternately arranged in surface contact with each other in the first direction (A-A). Each of the coolant jackets (30) is connected to coolant circulation pipes (40) provided on both sides in the second direction (B-B). At least a part of the coolant jackets (30) is a reinforcing plate-type coolant jacket (30R) configured such that upper parts of both ends in the second direction (B-B) of the reinforcing plate-type coolant jacket are extended in the second direction (B-B) and are joined to upper parts of end plates (13 and 14) constituting both end parts of the battery case (10) in the second direction (B-B) while avoiding the coolant circulation pipes (40) to enhance a rigidity of the battery case (10).

With this configuration, the rigidity of the battery case can be improved to reduce the deflection of the battery pack while maintaining the quantity of mounted battery cells, the battery capacity, and the cooling function for the battery cells.

Since an arrangement of the reinforcing plate-type coolant jacket (30R) is determined by a relationship between the case and the quantity, depending on a cell size to be installed, one reinforcing plate-type coolant jacket (30R) may be provided for each three coolant jackets (30) arranged in the first direction (A-A), one reinforcing plate-type coolant jacket (30R) may be provided for each four coolant jackets (30) arranged in the first direction (A-A), or one reinforcing plate-type coolant jacket (30R) may be provided for each five coolant jackets (30) arranged in the first direction (A-A).

With these configurations, the rigidity of the battery case can be improved while maintaining the battery capacity and the cooling function for the battery cells.

The reinforcing plate-type coolant jacket (30R) may be provided each 200 mm±20 mm in the first direction (A-A) of the battery case.

With this configuration, in the case of the actual battery case dimensions, i.e., about 1500 mm to 2000 mm, the rigidity of the battery case can be improved while maintaining the battery capacity and the cooling function for the battery cells.

The upper parts (30c) of the both end parts of the reinforcing plate-type coolant jacket (30R) in the second direction (B-B) may be configured to fit into notches (13a and 14a) provided at the end plates (13 and 14) constituting the both end parts of the battery case (10) in the second direction (B-B).

With this configuration, since the position of the reinforcing plate-type coolant jacket is fixed, in addition to the above effects, the position of each battery cell can be defined.

The coolant circulation pipes (40) may include: an inlet side socket (41) connected to a one end part (30a) of the coolant jacket (30) in the second direction (B-B); and an outlet side socket (42) connected to an other end part (30b) of the coolant jacket (30) in the second direction (B-B). The inlet side socket (41) may include a one surface side inlet pipe (41a) protruding in the first direction (A-A) from a one surface side, and an other surface side inlet pipe (41b) protruding in the first direction (A-A) from an other surface side. The outlet side socket (42) may include a one surface side outlet pipe (42a) protruding in the first direction (A-A) from the one surface side, and an other surface side outlet pipe (42b) protruding in the first direction (A-A) from the other surface side. Upon bringing two of the coolant jackets (30) adjacent to each other with the cell joined body (20A) interposed therebetween, the one surface side inlet pipe (41a) of the inlet side socket (41) and the one surface side outlet pipe (42a) of the outlet side socket (42) connected to one of the coolant jackets (30) may be respectively connected to the other surface side inlet pipe (41b) of the inlet side socket (41) and the other surface side outlet pipe (42b) of the outlet side socket (42) connected to the other of the coolant jackets (30).

With this configuration, by bringing the cell joined bodies closer to each other in a state in which the inlet side socket and the outlet side socket are combined with each coolant jacket in advance, since the sockets can connect to each other themselves to form a coolant flow path, assembly workability can be improved.

A manufacturing method of a battery pack according to another embodiment of the disclosure is a method of manufacturing a battery pack (1) including: a battery case (10) in a substantially box shape extending in a first direction (A-A) and a second direction (B-B) that form a horizontal plane and are orthogonal to each other; a plurality of battery cells (20) arranged in the battery case (10); and a plurality of coolant jackets (30) including coolant passages (34) therein and cooling the plurality of battery cells (20). The manufacturing method includes steps below. The plurality of battery cells (20) are arranged and joined, with multiple battery cells in each row in the second direction (B-B), to form a plurality of cell joined bodies (20A). The cell joined body (20A) and the coolant jacket (30) are arranged alternately in surface contact with each other in the first direction (A-A) in the battery case (10). Upper parts of both end parts in the second direction (B-B) of at least a part of the coolant jackets (30) are joined to upper part of end plates (13 and 14) constituting both end parts of the battery case (10) in the second direction (B-B) to enhance a rigidity of the battery case (10).

With this configuration, the rigidity of the battery case can be improved while maintaining the battery capacity and the cooling function for the battery cells.

The reference signs in brackets above indicate reference signs of components corresponding to embodiments to be described later as examples of the disclosure.

With the frame structure of the disclosure, it is possible to achieve both improvement in a battery mounting amount and suppression of a rigidity decrease in the battery case to be capable of dealing with cruising range improvement of an electric vehicle and a voltage increase.

Further, in the disclosure, by integrating functions of a frame with a coolant jacket cooling one side surface of a battery, it becomes possible to significantly suppress heat generation during charging without reducing the battery mounting quantity, and it becomes possible to achieve rapid charging. By forming slits at the side frames (outer frames) of the case and fitting protrusions into the slits, it is possible to not only further improve the rigidity, but the frames are also caused to function to define the positions of the batteries. Furthermore, this form of joining only the upper parts with a small quantity of frames exhibits improved disassembly properties and is suitable for resource circulation because attached portions are few.

Hereinafter, embodiments of the disclosure will be described in detail with reference to the accompanying drawings.

### First Embodiment

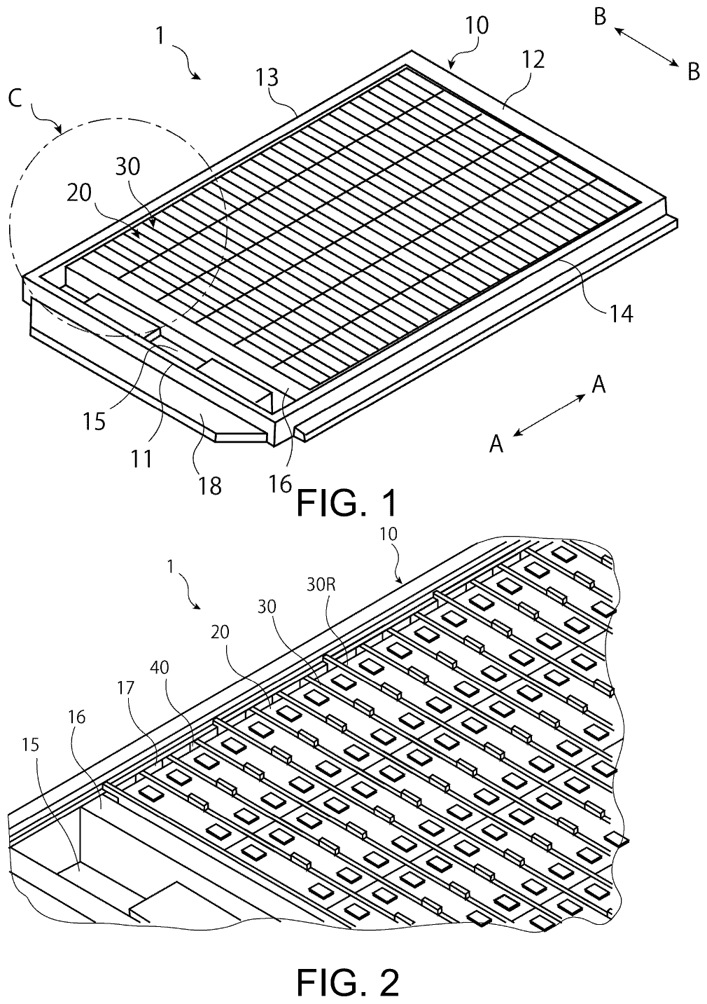

This embodiment is a configuration in which upper parts of both end parts of a reinforcing plate-type coolant jacket are joined to upper parts of side end plates of a battery case. As shown in FIG. 1 and its enlarged view of a part C in FIG. 2, a battery pack 1 of this embodiment is composed of a battery case 10, a plurality of battery cells 20, a plurality of coolant jackets 30, and a coolant circulation pipe 40.

The battery case 10 is a thin box-shaped case extending in a first direction (front-rear direction A-A) and a second direction (left-right direction B-B) that are orthogonal to each other and form a horizontal plane. The battery case 10 is composed of a front end plate 11 and a rear end plate 12 that are provided at both end parts in the first direction, a left end plate 13 and a right end plate 14 that are provided at both end parts in the second direction and are composed of an extruded material, a bottom plate 15, and an upper plate (not shown). A partition plate 16 is provided near the front end plate 11 on an inner side, and a battery cell accommodating part 17 is formed on its rear side. Further, a buffer member 18 in a substantially trapezoidal shape in a plan view is provided on a front side of the front end plate 11 and is configured to be capable of absorbing an impact from outside when the battery pack 1 is provided at a bottom part of a vehicle body.

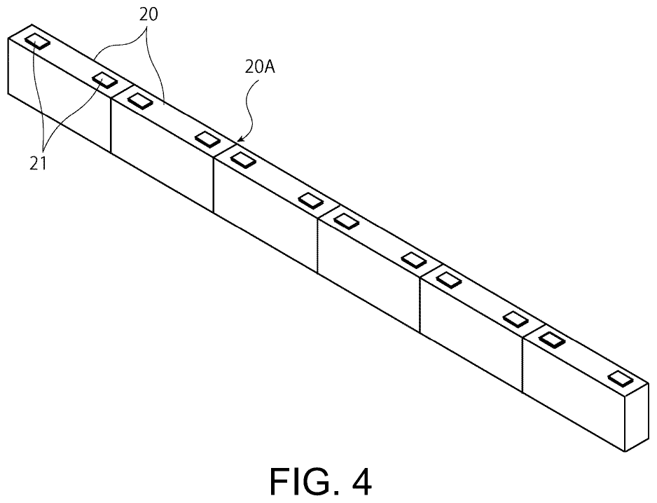

As shown in FIG. 4, in this embodiment, the battery cell 20 is a rectangular lithium-ion battery, with two terminals 21 protruding on an upper side. The battery cells 20 form a cell joined body 20A with six battery cells 20 arranged and joined in a row in the second direction (left-right direction). However, the shape of the battery cell 20 in the disclosure is not limited to a rectangular shape and may also be, for example, a cylindrical shape. Nonetheless, there are advantages to adopting a rectangular shape, such as not requiring a resin to fill between the battery cells 20 and having less environmental impact during recycling. Further, the type of the battery is not limited to a lithium-ion battery and may also be an all-solid-state lithium-ion battery or a sodium-ion battery.

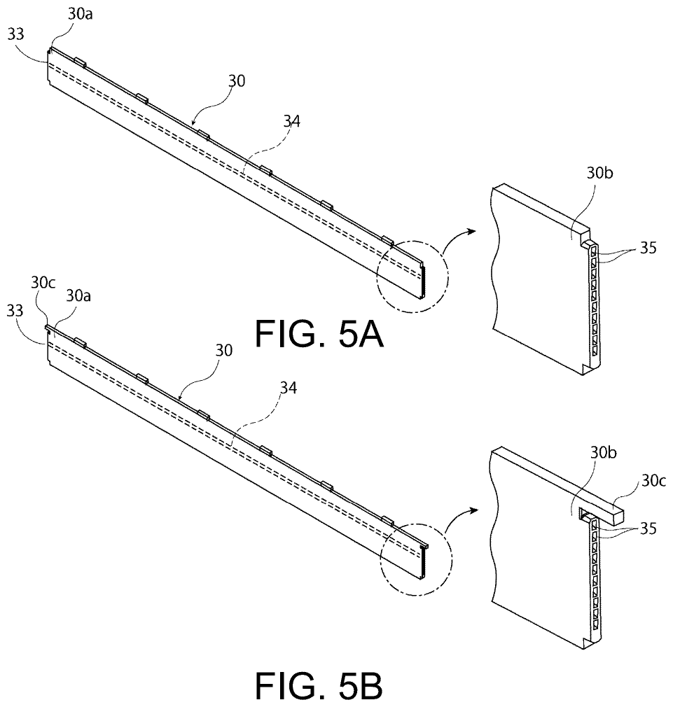

The coolant jacket 30 is a component that is alternately arranged in surface contact with the cell joined body 20A in the first direction (front-rear direction) in the battery case 10 and cools each battery cell 20. As shown in FIG. 5A and FIG. 5B, each coolant jacket 30 is composed of an aluminum extruded member of a predetermined thickness in a rectangular shape having substantially same length and height as the cell joined body 20A, and includes a coolant inlet 33 provided at a left end surface 30a, a coolant passage 34 provided inside, and a coolant outlet 35 provided at a right end surface 30b. However, the coolant jacket 30 is not limited to an extruded member and may also be formed by, for example, surface-joining a plate having a groove on its surface with another plate, with the groove serving as a coolant flow path.

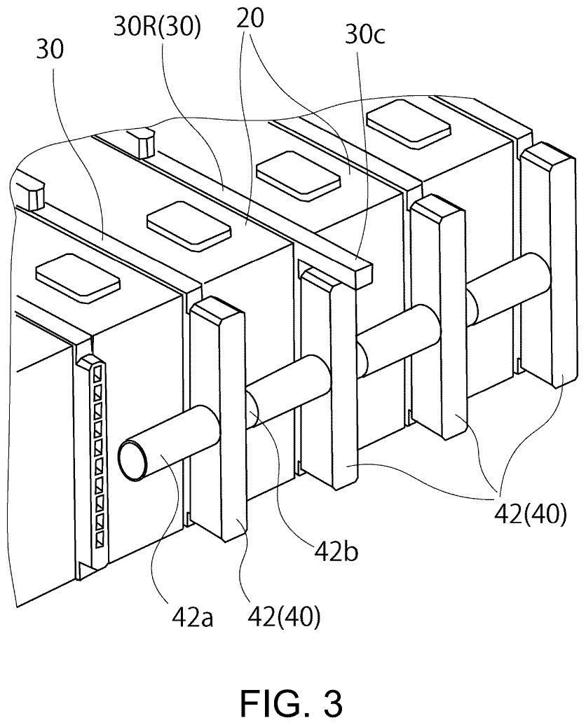

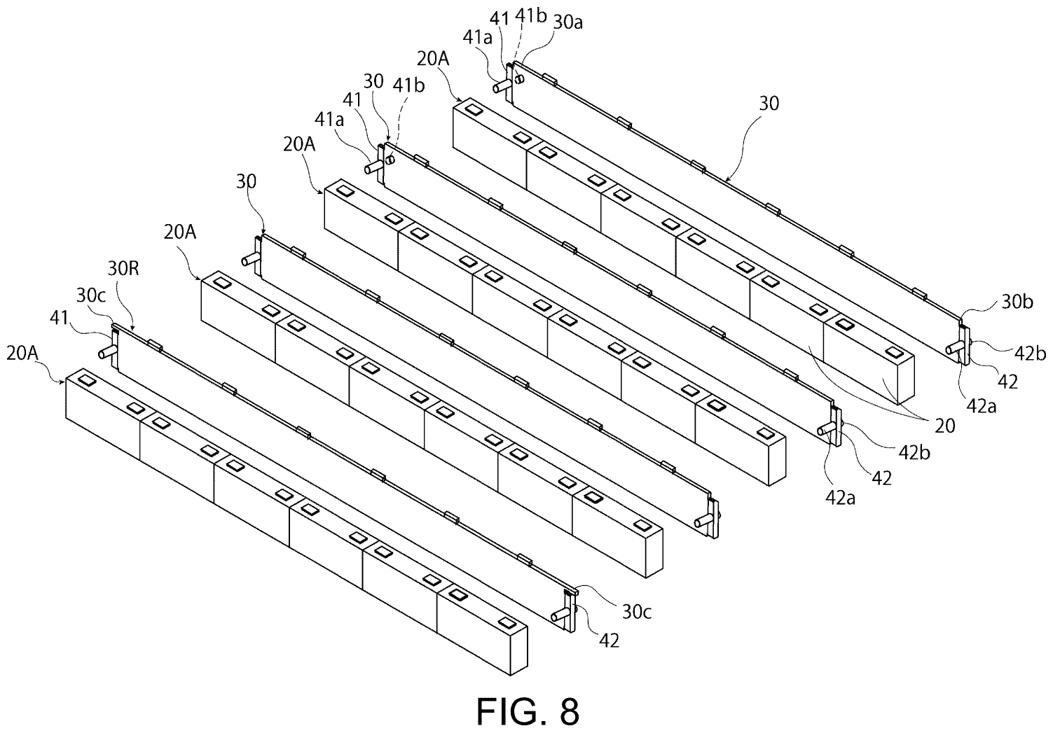

As shown in FIG. 3 and FIG. 8, the coolant circulation pipe 40 includes an inlet side socket 41 connected to a one end part (left end part) in the second direction (left-right direction) of the coolant jacket 30, and an outlet side socket 42 connected to an other end part (right end part) of the coolant jacket 30. The inlet side socket 41 includes a one surface side inlet pipe 41a protruding in the first direction from a one surface side (front side), and an other surface side inlet pipe 41b protruding in the first direction from an other surface side (rear side). On the other hand, the outlet side socket 42 includes a one surface side outlet pipe 42a protruding in the first direction from the one surface side (front side), and an other surface side outlet pipe 42b protruding in the first direction from the other surface side (rear side).

When two coolant jackets 30 are brought adjacent to each other with the cell joined body 20A interposed therebetween, the one surface side inlet pipe 41a of the inlet side socket 41 and the one surface side outlet pipe 42a of the outlet side socket 42 connected to one of the coolant jackets 30 are, for example, respectively fitted and connected to the other surface side inlet pipe 41b of the inlet side socket 41 and the other surface side outlet pipe 42b of the outlet side socket 42 connected to the other of the coolant jackets 30. FIG. 3 shows such a connection structure on the outlet side. In this manner, all the inlet side sockets 41 of the coolant jackets 30 arranged in the battery case 10 are connected to each other, and the outlet side sockets 42 are also connected to each other. A one surface side inlet pipe 41a of the frontmost stage and a one surface side outlet pipe 42a of the frontmost stage are not provided, and the one surface side is sealed. On the other hand, a coolant supply pipe (not shown) is connected to the other surface side inlet pipe 41b of the last stage, and a coolant return pipe (not shown) is connected to the one surface side outlet pipe 42a of the last stage. When a coolant (water) is supplied from the coolant supply pipe (not shown) to a group of coolant jackets 30 connected in this manner, this water branches and flows in parallel into the coolant passage 34 of each coolant jacket 30 to cool the battery cells 20, and merges to flow into the coolant return pipe (not shown).

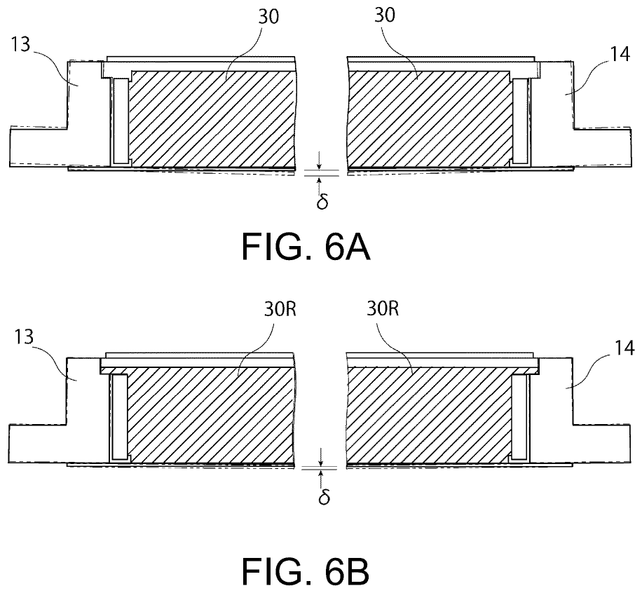

Herein, at least a part of the coolant jackets 30 is a reinforcing plate-type coolant jacket 30R configured such that its upper parts 30c of both end parts in the second direction (left-right direction) extend in the second direction, and are joined to upper parts of the left end plate 13 and the right end plate 14 constituting both end parts in the second direction (left-right direction) of the battery case 10 while avoiding the sockets (41 and 42) of the coolant circulation pipe 40, to enhance a rigidity of the battery case 10. Since the battery pack 1 of this embodiment is thin and is mounted with many battery cells 20, when the battery pack 1 is horizontally arranged with its left and right end parts supported by a bottom part or the like of an automobile, it tends to deflect with a central part sagging due to its own weight. In that case, as shown in FIG. 6A, it is conceivable that the left end plate 13 and the right end plate 14, each composed of an extruded material, of the battery case 10 respectively undergo a torsional deformation such that their upper parts approach each other (double dot dashed lines in FIG. 6A). Thus, as shown in FIG. 6B, when the upper parts 30c of both end parts of the reinforcing plate-type coolant jacket 30R are respectively joined to the upper parts of the left end plate 13 and the right end plate 14, due to the rigidity of the reinforcing plate-type coolant jacket 30R, approaching between the upper parts of the left end plate 13 and the right end plate 14 can be suppressed, and a deflection amount 6 of the battery pack 1 can be reduced (double dot dashed lines in FIG. 6B).

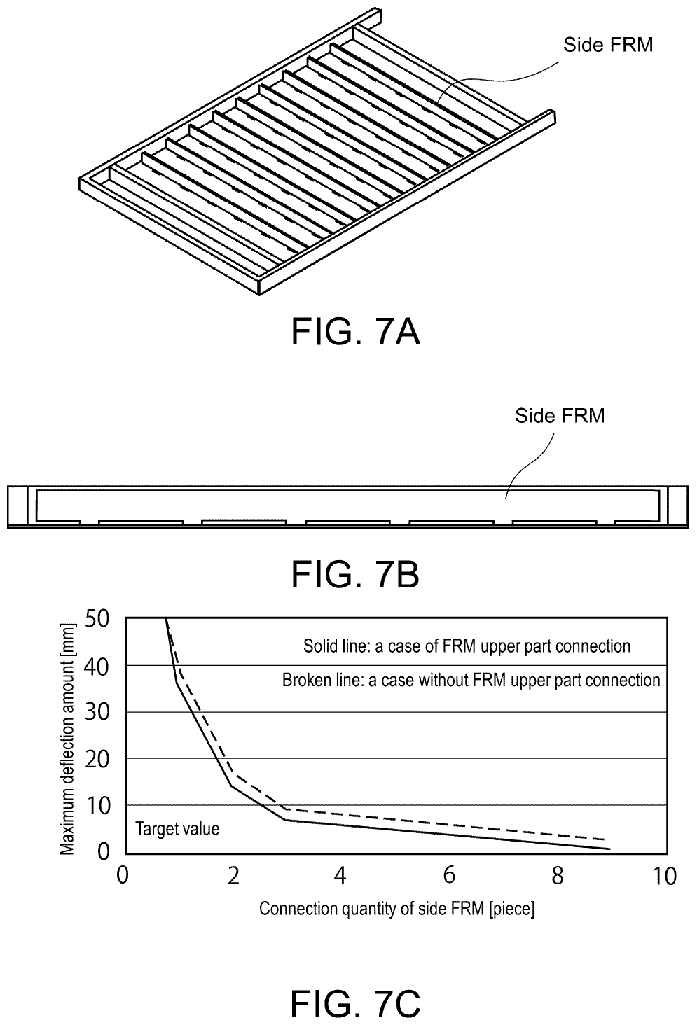

However, if all the coolant jackets 30 are configured as reinforcing plate-type coolant jackets 30R, joining processes between the upper parts of both end parts of the reinforcing plate-type coolant jackets 30R and the upper parts of the left end plate 13 and the right end plate 14 increase during manufacturing of the battery pack 1, and disassembly processes during recycling also increase. Thus, in this embodiment, the reinforcing plate-type coolant jackets 30R are configured only in a quantity necessary and sufficient for reducing the deflection amount 6 of the battery pack 1 to a predetermined value. FIG. 7A, FIG. 7B, and FIG. 7C show side frames (FRM) (8 mm aluminum plates) approximating the reinforcing plate-type coolant jackets 30R and a simulation result of a relationship between a quantity of the side frames and a deflection amount 6 of the battery pack, in a battery pack of a cell-to-pack structure of 1800 mm in the first direction by 1200 mm in the second direction with a load of 5500 N (561 kgf). Accordingly, if nine reinforcing plate-type coolant jackets 30R equivalent to the side FRMs connected at the upper parts are provided in the first direction, the deflection amount 6 becomes equal to or less than a target of 1 mm. In other words, if the reinforcing plate-type coolant jacket 30R is provided each 200 mm in the first direction, the deflection amount 6 can be set to 1 mm or less.

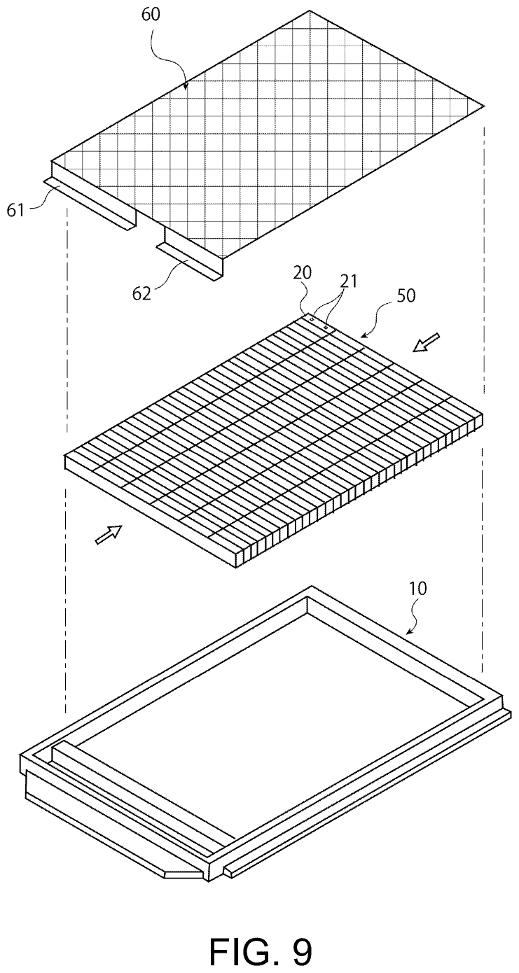

As shown in FIG. 9, the two terminals 21 provided on the upper surface of each battery cell 20 are connected by welding to a bus bar module 60, which is a copper plate with a stamped wiring circuit, and are connected in parallel and in series in the wiring circuit to be eventually integrated into a positive side terminal 61 and a negative side terminal 62. Each battery cell 20 may be charged by applying a voltage between the positive side terminal 61 and the negative side terminal 62 from outside, and the power charged in each battery cell 20 may also be supplied from the positive side terminal 61 and the negative side terminal 62 to an automobile drive motor and the like.

Next, a manufacturing method of the battery pack 1 of this embodiment configured in this manner will be described.

First, as shown in FIG. 8, a plurality of battery cells 20 are joined, with multiple (six in this embodiment) battery cells 20 arranged in each row in the second direction (left-right direction), to form a cell joined body 20A. On the other hand, sockets 41 and 42 are connected to both end parts 30a and 30b of coolant jackets 30 and 30R.

Next, the cell joined body 20A and the coolant jacket 30 are alternately arranged in surface contact with each other and adhered to each other in the first direction (front-rear direction A-A). At this time, one coolant jacket 30 of each plurality (four in this embodiment) of coolant jackets 30 is configured as a reinforcing plate-type coolant jacket 30R having upper parts 30c of both end parts extended in the second direction.

Further, at this time, of two coolant jackets 30 sandwiching a cell joined body 20A, the one surface side inlet pipe 41a of the inlet side socket 41 and the one surface side outlet pipe 42a of the outlet side socket 42 connected to one of the coolant jackets 30 are respectively fitted and connected to the other surface side inlet pipe 41b of the inlet side socket 41 and the other surface side outlet pipe 42b of the outlet side socket 42 connected to the other of the coolant jackets 30.

Next, as shown in FIG. 9, a cell stack 50 thus formed is inserted into a battery case 10, and thereafter, a bus bar module 60 with a wiring circuit configured thereon is placed on a surface (upper surface in FIG. 9) on which the terminals 21 of each battery cell 20 are arranged, and is welded to each terminal 21 to form a cell body 70.

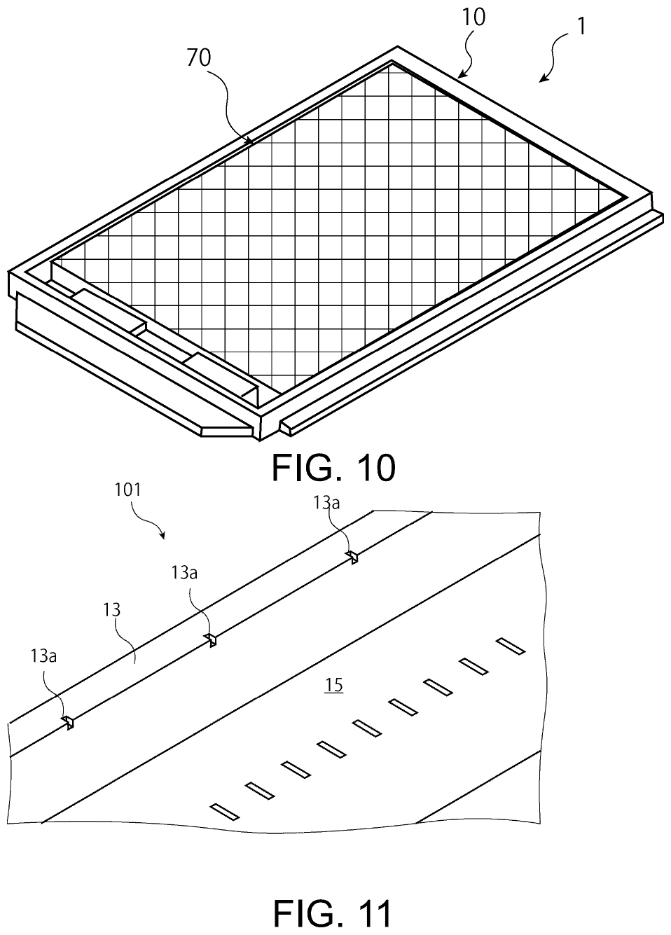

The cell body 70 with the battery case 10 formed in this manner is shown in FIG. 10. Furthermore, by connecting a coolant supply pipe (not shown), a coolant return pipe (not shown), etc., filling a urethane foam into gaps around the cell body 70 as necessary, and adhering an upper plate (not shown), a battery pack 1 is completed.

According to this embodiment, the upper parts 30c of both end parts of the reinforcing plate-type coolant jacket 30R are joined to the upper parts of the left endplate 13 and the right end plate 14 of the battery case 10 while avoiding the sockets (41 and 42) of the coolant circulation pipe 40. Thus, the rigidity of the battery case 10 can be enhanced, and the socket connection mechanism of the coolant circulation pipe 40 can be used.

### Second Embodiment

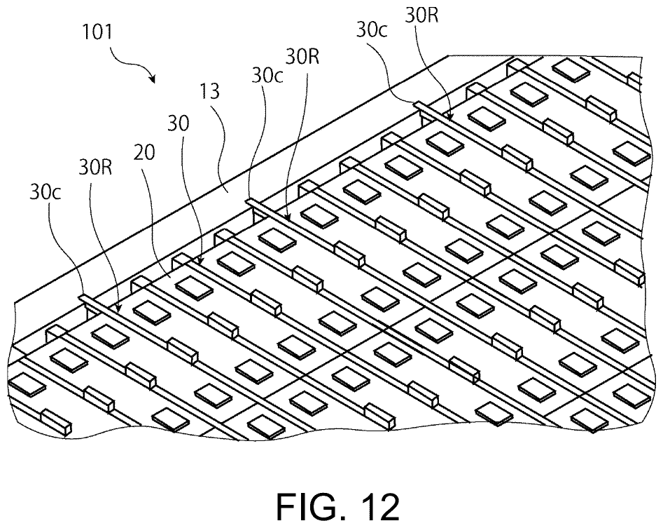

This embodiment is a form in which the upper parts 30c of both end parts of the reinforcing plate-type coolant jacket 30R in the second direction are fitted into notches 13a and 14a provided at the end plates (13 and 14) constituting both end parts of the battery case 10 in the second direction (left-right direction B-B). The same or substantially the same components as those in the first embodiment will be labeled with the same reference signs, and repeated descriptions thereof will be are omitted. FIG. 11 is a perspective view showing a portion of a left end plate 13 of a battery case 10 in a battery pack 101 according to this embodiment. As shown in FIG. 11, three notches 13a are provided at an inner corner part of the left end plate 13. Although not all shown, a total of nine notches 13a are provided at the left end plate 13, and a total of nine notches 14a are also provided at the right end plate 14. FIG. 12 is a partially enlarged perspective view of the battery pack 101 with battery cells 20 and coolant jackets 30 and 30R mounted in this battery case 10, and is a perspective view showing a state in which the upper part 30c of the left end part of the reinforcing plate-type coolant jacket 30R is fitted into each notch 13a (see FIG. 11). Although not all shown, the upper parts 30c of the left or right end parts of the reinforcing plate-type coolant jackets 30R are also fitted into other notches 13a of the left end plate 13 and notches 14a of the right end plate 14. Configurations other than this are the same as those of the first embodiment.

With this configuration, since a joined surface between each notch 13a and 14a and the upper parts 30c of both end parts of the reinforcing plate-type coolant jacket 30R increases, the joining strength increases, and the rigidity of the battery case 10 further improves. Furthermore, since the position of the reinforcing plate-type coolant jacket 30R in the first direction (front-rear direction A-A) is partially determined according to the positions of the notches 13a and 14a, a positional precision of each battery cell 20 improves, and a positional precision of the terminals 21 of the battery cell 20 improves. Accordingly, it is possible to relax a positioning required precision of the bus bar module 60 for the cell stack 50 including each battery cell 20 in a subsequent bus bar module joining process, and it is possible to miniaturize components, reduce processing costs, etc.

Although the embodiments of the disclosure have been described above, the disclosure is not limited to these embodiments, and various modifications may be made within the scope of the patent claims and the technical concepts described in the specification and drawings. For example, in each of the above embodiments, a coolant circulation pipe 40 connecting the inlet side sockets 41 and the outlet side sockets 42 in a predetermined structure is used, but the disclosure is not limited thereto, and any structure may be used as long as it can be connected to left and right end parts 30a and 30b on the coolant jackets 30 and 30R.

Further, in each of the above embodiments, one reinforcing plate-type coolant jacket 30R is provided for each four coolant jackets 30 arranged in the first direction. However, one reinforcing plate-type coolant jacket 30R may also be provided for each three, each five, or any quantity of coolant jackets 30.

What is claimed is:

1. A battery pack comprising:
a battery case in a substantially box shape extending in a first direction and a second direction that are orthogonal to each other and form a horizontal plane;
a plurality of battery cells arranged in the battery case; and
a plurality of coolant jackets comprising coolant passages therein and cooling the plurality of battery cells, wherein
the plurality of battery cells constitute cell joined bodies each with multiple battery cells arranged and joined in a row in the second direction,
the cell joined body and the coolant jacket are alternately arranged in surface contact with each other in the first direction, and
each of the coolant jackets is connected to coolant circulation pipes provided on both sides in the second direction, and at least a part of the coolant jackets is a reinforcing plate-type coolant jacket configured such that upper parts of both end parts in the second direction of the reinforcing plate-type coolant jacket are extended in the second direction and are joined to upper parts of end plates constituting both end parts of the battery case in the second direction while avoiding the coolant circulation pipes to enhance a rigidity of the battery case.

2. The battery pack according to claim 1, wherein one reinforcing plate-type coolant jacket is provided for each three coolant jackets arranged in the first direction.

3. The battery pack according to claim 1, wherein one reinforcing plate-type coolant jacket is provided for each four coolant jackets arranged in the first direction.

4. The battery pack according to claim 1, wherein one reinforcing plate-type coolant jacket is provided for each five coolant jackets arranged in the first direction.

5. The battery pack according to claim 1, wherein the reinforcing plate-type coolant jacket is provided each 200 mm±20 mm in the first direction of the battery case.

6. The battery pack according to claim 1, wherein the upper parts of the both end parts of the reinforcing plate-type coolant jacket in the second direction fit into notches provided at the end plates constituting the both end parts of the battery case in the second direction.

7. The battery pack according to claim 1, wherein
the coolant circulation pipes comprise:
an inlet side socket connected to a one end part of the coolant jacket in the second direction; and
an outlet side socket connected to an other end part of the coolant jacket in the second direction,
the inlet side socket comprises a one surface side inlet pipe protruding in the first direction from a one surface side, and an other surface side inlet pipe protruding in the first direction from an other surface side,
the outlet side socket comprises a one surface side outlet pipe protruding in the first direction from the one surface side, and an other surface side outlet pipe protruding in the first direction from the other surface side, and
upon bringing two of the coolant jackets adjacent to each other with the cell joined body interposed therebetween, the one surface side inlet pipe of the inlet side socket and the one surface side outlet pipe of the outlet side socket connected to one of the coolant jackets are respectively connected to the other surface side inlet pipe of the inlet side socket and the other surface side outlet pipe of the outlet side socket connected to the other of the coolant jackets.

8. A manufacturing method of a battery pack, which is a manufacturing method of manufacturing a battery pack comprising:
a battery case in a substantially box shape extending in a first direction and a second direction that form a horizontal plane and are orthogonal to each other;
a plurality of battery cells arranged in the battery case; and
a plurality of coolant jackets comprising coolant passages therein and cooling the plurality of battery cells,
the manufacturing method comprising:
arranging and joining the plurality of battery cells with multiple battery cells in each row in the second direction to form a plurality of cell joined bodies;
arranging the cell joined body and the coolant jacket alternately in surface contact with each other in the first direction in the battery case; and
joining upper parts of both end parts in the second direction of at least a part of the coolant jackets to upper parts of end plates constituting both end parts of the battery case in the second direction to enhance a rigidity of the battery case.
